(19) United States
(12) Patent Application Publication
(10) Pub. No.: US 2020/0380030 A1
(43) Pub. Date: Dec. 3, 2020

(54) IN-APPLICATION VIDEO NAVIGATION SYSTEM

(71) Applicant: ADOBE INC., SAN JOSE, CA (US)

(72) Inventors: Anthony Michael Colas, San Jose, CA (US); Doo Soon Kim, San Jose, CA (US); Franck Dernoncourt, Sunnyvale, CA (US); Seokhwan Kim, San Jose, CA (US)

(21) Appl. No.: 16/428,308

(22) Filed: May 31, 2019

(51) Int. Cl. G06F 16/73; G10L 15/22; G09B 7/02

(52) U.S. Cl. CPC G06F 16/73; G10L 15/22; G06F 3/167; G10L 2015/223; G09B 7/02

(57) ABSTRACT

Embodiments of the present invention provide systems, methods, and computer storage media for in-app video navigation in which videos including answers to user provided queries are presented within an application. And portions of the videos that specifically include the answer to the query are highlighted to allow for efficient and effective tutorial utilization. Upon receipt of a text or verbal query, top candidate videos including an answer to the query are determined. Within the top candidate videos, a video span with a starting sentence location and an ending location is identified based on the query and contextual information within each candidate video. The video span with the highest overall score calculated based on a video score and a span score is presented to the user.

### BACKGROUND

Video tutorials have become an integral part of day-to-day life, especially in the context of the modern era of software applications. Generally, each software application has a variety of functionalities unique to the application. The goal of video tutorials is to help instruct, educate, and/or guide a user to perform tasks within the application. Conventionally, web browsers are used to access such tutorials. A query in the form of a question may be presented using a web search browser (e.g., GOOGLE®, BING®, YAHOO®, YOUTUBE®, etc.), and the search browser presents all possible relevant tutorials to the user. Once located, the video tutorial is generally played or watched via the web browser. Oftentimes, however, the video tutorials can be entirely too long for accurate recall. As such, users can be forced to switch between the web browser playing the tutorial and the application about which the user is learning to follow the instructions and to perform the associated task, segment-by-segment. Such a workflow requires the user to stop and resume the video in the browser multiple times to perform the associated task in the application. In some cases, only a section of the video may be relevant to the user's inquiry. Here, a user must manually find the relevant portion of the video to perform the needed task.

The video tutorial relied is generally desired to be application specific for it to be useful. Moreover, software applications frequently come out with newer versions. The video tutorials relied on by the user are desired to correspond to the correct version of the application being used by the user. Because application specific video tutorial are valuable, video tutorial systems may be used to provide step-by-step instructions in text, image, and/or other formats during or prior to application use. Video tutorial systems aim to assist users in learning how to use certain parts or functionalities of a product. Many video tutorial systems use a table of contents to provide instructions on use of applications for various tasks. Based on a user query, the video tutorial system presents a list of tutorials, video and/or text based, that may be relevant to the user query. However, the current systems require users to manually navigate through the tutorials and/or the table of contents to find first the right tutorial, and then the right section of the tutorial to perform the relevant task. Additionally, the current systems require the user to leave the application to watch video tutorials in a web browser to learn and perform every step presented in the video tutorial. This process can be extremely time consuming and inefficient. It may take various attempts for a user to both find the right instructions and perform them accurately.

### SUMMARY

Embodiments of the present invention are directed to an in-application (“in-app”) video navigation system in which a video span with an answer to a user's query is presented to the user within an application window. In this regard, a user may input a query (e.g., a natural language question via text, voice command, etc.) within an application. The query can be encoded to a query embedding in a vector space using a neural network. A database of videos may be searched from a data store including sentence-level and/or passage level embeddings of videos. Top candidate videos may be determined such that the candidate videos include a potential answer to the query. For each of the candidate videos, an answer span within the video may then be determined based on a sentence level encoding of the respective candidate video. The spans for each candidate video may then be scored in order to determine the highest scoring span. The highest scoring answer span can then be presented to the user in form of an answer to the query. The answer span may be presented by itself or within the candidate video with markings within a timeline of the candidate video (e.g., highlighting, markers at start and end of the span, etc.) pointing to the span within the video. As such, a user can be efficiently and effectively guided towards an answer to the query without having to leave the application or watching long videos to find a specific portion including the answer.

### BRIEF DESCRIPTION OF THE DRAWINGS

The present invention is described in detail below with reference to the attached drawing figures, wherein:

FIG. 1 is a block diagram of an exemplary environment suitable for use in implementing embodiments of the invention, in accordance with embodiments of the present invention;

FIG. 2A illustrates an example video module of an in-app video navigation system, in accordance with embodiments of the present invention;

FIG. 2B illustrates an example video encoder of an in-app video navigation system, in accordance with embodiments of the present invention;

FIG. 2C illustrates an example span determiner of an in-app video navigation system, in accordance with embodiments of the present invention;

FIG. 3A illustrates an example in-app video navigation interface, in accordance with embodiments of the present invention;

FIG. 3B illustrates another example in-app video navigation interface, in accordance with embodiments of the present invention

FIG. 4 illustrates an example video segmentation and embedding algorithm, in accordance with embodiments of the present invention;

FIG. 5 illustrates an embodiment of an overall architecture for in-app video navigation system, in accordance with embodiments of the present invention;

FIG. 6 is a flow diagram showing a method for generating video answer spans within an application, in accordance with embodiments described herein;

FIG. 7 is a flow diagram showing a method for presenting a video tutorial including an answer to a query within an application, in accordance with embodiments described herein; and

FIG. 8 is a block diagram of an exemplary computing environment suitable for use in implementing embodiments of the present invention.

### DETAILED DESCRIPTION

### Overview

Conventional video tutorial systems utilize one or more of step-by-step guidance, gamification, and manual retrieval approaches to provide instructions on how to perform tasks in an application. For example, some conventional in-application (“in-app”) tutorial systems provide step-by-step instructions using text or images. This requires a user to peruse the text to find the relevant portion to use to perform a specific task. Additionally, this requires a user to read each step before performing it. Some other conventional in-app tutorial systems use gamification to teach users how to perform tasks. Typically, this includes pointing based tutorials prior to application use. In other words, the gamification-based tutorials are training tutorials presented to a user prior to using an application. Pointing based tutorials provide interactive instructions for user by directing a user's attention, via pointing, to certain aspects of an application while providing blurbs explaining how the particular aspect may be used within the application. Some other tutorial systems use catalogues or lists of videos for a user to choose from when searching for a video tutorial to watch. These approaches require a user to manually navigate a list of videos or applications to find a relevant video. Such manual navigation is inefficient and time consuming for users as users have to peruse a large database of tutorials to find the relevant tutorial. Oftentimes, a user may not be able to find relevant tutorials and/or portions of the relevant tutorials at all, leading to user frustration and decreased user satisfaction. Moreover, the conventional approaches do not allow a user access to relevant video tutorials while using the application, requiring a user to leave the application workspace to watch the tutorials. This furthers adds to user frustration as the user has to switch back and forth between the tutorial window and the application workspace to complete a task.

Embodiments of the present invention address the technical problem of providing video segments and/or spans in response to a user query or question within an application video, such that a user may watch a relevant portion of a video tutorial while simultaneously performing the instructions in the application in the same window. In operation and at a high level, a neural network may be used to determine a video and an associate span within the video that answers a question asked by a user via a natural language text or voice query within an application. The neural network may identify a video tutorial and a span (i.e., a start and an end sentence) within the video tutorial that includes an answer to the question. To do so, the neural network may first retrieve top candidate videos from a video repository based on the question. In some embodiments, the neural network may also use context information, such as past queries, application version, etc., to retrieve top candidate videos. Next, within each of the top candidate videos, the neural network may determine a span that includes a potential answer to the question. The spans from each of the top candidate videos may then be ranked based on relevance to the query and the context information. The highest scored span and the associated video may then be presented to the user as an answer to the query.

In some embodiments, the video may be presented, via a user interface, with the span highlighted within the video, in the application itself. The user interface may allow the user to perform various functions, including pausing and/or resuming the video, navigating to different portion of the video, etc., within the application. The user may also navigate straight to the span with the relevant portion of the tutorial without having to watch the entire video from the beginning or searching through a database or table of contents. In an embodiment, the user may also be presented with a table of contents associated with the video. This provides the user with an alternative way of navigating through the video.

Aspects of the technology disclosed herein provide a number of advantages over previous solutions. For instance, one previous approach involves a factoid question answering system that finds a word or a phrase in a given textual passage containing a potential answer to a question. The system works on word level, to find a sequence of words to answer a who/what/why question. However, generating an answer span containing a word or a phrase has a significant drawback when it comes to determining answer spans in a video tutorial. Video tutorials are based on the premise of answering “how to” questions, and a one word or phrase answer may not be appropriate to present a user with instructions on how to perform a particular task. To avoid such constraints on the answers contained in video tutorials, the implementations of the technology described herein, for instance, systematically develops an algorithm to segment a video tutorial into individual sentences and consider all possible spans (i.e., starting sentence and ending sentence) within the video to determine the best possible span to answer a question or a query. The implementations of the present technology may allow for a sequence of sentences within a video tutorial to be an answer span, allowing the span to fully answer a question. Additionally, the implementations of the present technology may also take as input context information (e.g., past commands, program status, user information, localization, geographical information, etc.) to further refine the search for an accurate answer span and/or video in response to a query or question.

Some other previous work addressed the problem of providing summarized versions of news videos in the form of video clips. Sections of a news video are segmented into separate videos based on topic of the news. However, segmenting a video into several parts based on topics has a significant drawback of assuming that the videos may only be divided based on the topics generated by the news cast. To avoid such constraints relating to pre-established segmentations, implementations of the technology described herein, for instance, systematically develop an algorithm to take the entirety of a video tutorial at individual sentence level and assess each combination of starting and ending sentence within the video tutorial to determine the best span to answer the query or a question. The algorithm used in the previous work does not allow for flexibility in answering new questions and does not use contextual information to find the correct video and span within the video to answer a user's query or question.

As such, the in-app video navigation system can provide an efficient and effective process that provides a user with a more relevant and accurate video span answering a query without having to leave the application as opposed to prior techniques. Although the description provided herein generally describes this technology in context of in-application video tutorial navigation, it can be appreciated that this technology can be implemented in other video search contexts. For example, the technology described herein may be implemented to present video answer spans in response to a video search query within a search database (e.g., GOOGLE®, BING®, YAHOO®, YOUTUBE®, etc.), a website, etc. Specifically, the present technology may be used to provide specific video spans as answers to video queries in any number of contexts wherein a video search is conducted, such that a user may be presented with a video including an indicated video span to answer the query, generated and presented in a way similar to the in-application video navigation system technology described herein.

Having briefly described an overview of aspects of the present invention, various terms used throughout this description are provided. Although more details regarding various terms are provided throughout this description, general descriptions of some terms are included below to provider a clearer understanding of the ideas disclosed herein:

A query generally refers to a natural language text or verbal input (e.g., a question, a statement, etc.) to a search engine configured to perform, for example, a video search. As such, a query may refer to a video search query. The query can be in the form of a natural language phrase or a question. A user may submit a query through an application via typing in a text box or voice commands. An automated speech recognition engine may be used to recognize the voice commands.

A query or question embedding (or encoding) generally refers to encoding a query in a vector space. A query can be defined as a sequence of words. The query may be encoded in a vector space using a bidirectional long short-term memory layer algorithm.

A command sequence generally refers to a sequence of commands executed by a user while in or using the application (e.g., icons used from a tool bar, menus selected, etc.). The command sequence may also include additional context information, such as, application status, user information, localization, geographical information, etc. The command sequence may be embedded as a command sequence encoding or embedding into a vector space. Command sequence encoding or embedding may refer to a last hidden vector in a vector space that represents the command sequence.

A sentence-level embedding, as used herein, refers to a vector representation of a sentence generated by an encoding into a joint vector space using a neural network. Generally, sentence-level embeddings may encode based on the meaning of the words and/or phrases in the sentence. By encoding a database of words and/phrases input into the vector space, a sentence can be encoded into a sentence-level embedding, and the closest embedded words, phrases or sentences (i.e., nearest embeddings in the vector space) can be identified.

A passage-level embedding (encoding), as used herein, refers to an encoding of a sentence into a joint vector space such that the embedding takes into account all prior and subsequent sentences in a video transcript. By encoding a database of sentences into the joint vector space, a sentence can be encoded into the passage-level embedding, and the latent meaning of the sentence may be represented in the vector space for the passage.

A span generally refers to a section of a video defined by a starting sentence location and an ending sentence location within a transcript of a video. A span can be any sentence start and end pair within the video transcript. An answer span, as used herein, refers to a span that includes an answer to a user query. An answer span can be the span with the highest score within the video.

A span score generally refers to a probability of a span to include an answer to a query as compared to the other spans in a video. A video score, on the other hand, refers to a probability of a video to include an answer to a query as compared to all other videos in a video repository or data store.

### Example in-App Video Navigation Environment

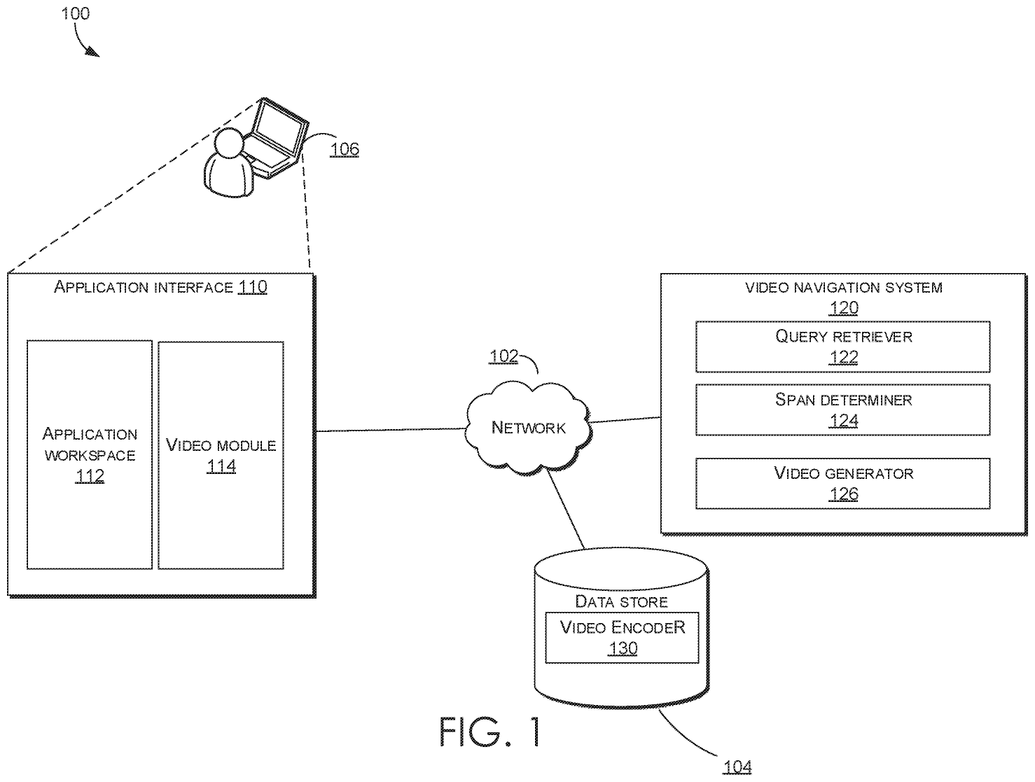

Referring now to FIG. 1, a block diagram of exemplary environment 100 suitable for use in implementing embodiments of the invention is shown. Generally, environment 100 is suitable for facilitating in-application (“in-app”) video navigation, and, among other things, facilitates determining and displaying video spans including an answer in response to a received query in an application workspace.

Environment 100 includes a network 102, a client device 106, and a video navigation system 120. In the embodiment illustrated in FIG. 1, client device 106 includes an application interface 110. Generally, the application interface 110 presents answer spans and/or video in response to a user query. Client device 106 can be any kind of computing device capable of facilitating a guided visual search. For example, in an embodiment, client device 106 can be a computing device such as computing device 900, as described below with reference to FIG. 9. In embodiments, client device 106 can be a personal computer (PC), a laptop computer, a workstation, a mobile computing device, a PDA, a cell phone, or the like.

Video navigation system 120 generally determines an answering span within a video present in data store 104 that best answers a user's query. The video navigation system 120 may include a query retriever 122, a span determiner 124, and a video generator 126. In some examples, video navigation system 120 may be a part of the video module 114. In other examples, video navigation system 120 may be located in a remote server.

The data store 104 stores a plurality of videos. In some examples, data store 104 may include a repository of videos collected from a variety of large data collection repositories. Data store 104 may include tutorial videos for a variety of application. The videos in data store 104 may be saved using an index sorted based on applications. The components of environment 100 may communicate with each other via a network 102, which may include, without limitation, one or more local area networks (LANs) and/or wide area networks (WANs). Such networking environments are commonplace in offices, enterprise-wide computer networks, intranets, and the Internet.

Generally, the foregoing process can facilitate generation of an answer span in response to a query within an application interface by searching within a data store of videos. By adopting an in-app approach to producing videos and/or specific spans within the videos to answer a user's query via machine learning techniques, there is no need for the user to leave an application to find an answer.

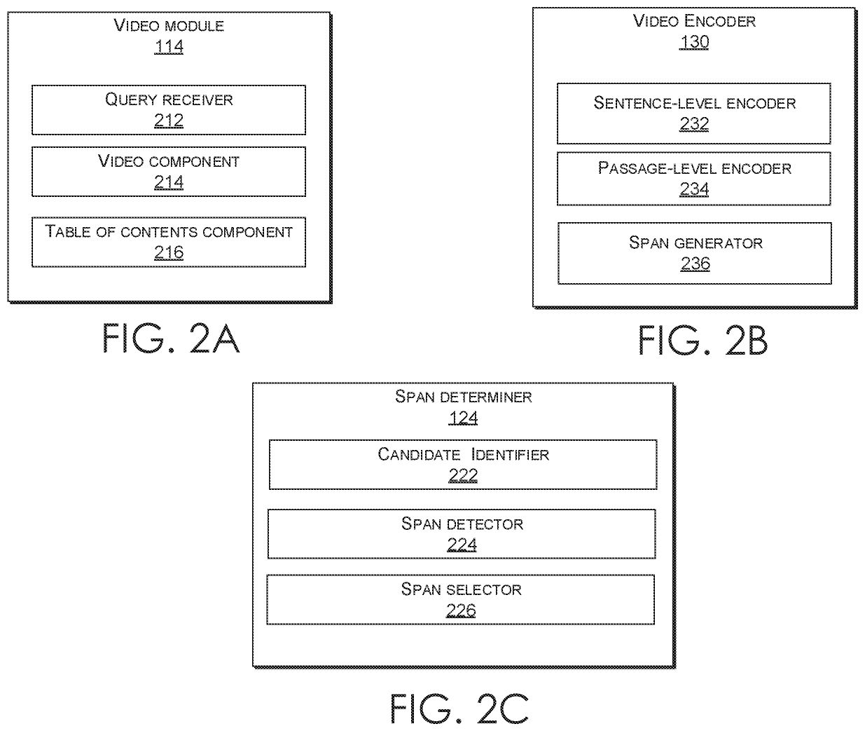

Application interface 110 presents a user with an answer(s) to a user provided query. In some embodiments, a query may be a question. The query may be a natural language query in the form of a textual query or a vocal query. Application interface 110 may receive a query from a user in the form of a text query via a keyboard or touchscreen of client device 106 or in the form of a voice command via a speech recognition software of client device 106. Application interface 110 may use a query receiver, such as but not limited to query receiver 212 of FIG. 2A, to receive the query.

Application interface 110 may include an application workspace 112 and a video module 114. Application workspace 112 may provide an area within an application interface 110 for a user to interact with the application in use. Video module 114 may present a user with an answer span and/or an answering video in response to the user query. Video module 104 may display an answer span by itself or within a video with markings within a timeline of the video (e.g., highlighting, markers at start and end of the span, etc.) pointing to the span within the video that includes a potential answer to the query. Video module 114 may receive the answer span and/or video from video navigation system 120 and present the answer span and/or video within the application interface 110 for further interaction by the user.

Video navigation system 120 is generally configured to receive a natural language query and determine an answer span that best answers the query. Video navigation system 120 may receive the query in the natural language form from the application interface 110. In some examples, video navigation system 120 may be a part of the video module 114. In other examples, video navigation system 120 may be located in a remote server, such that video module 114 and/or application interface 110 may communicate with video navigation system 120 via network 102. Video navigation system 120 may include a query retriever 122, a span determiner 124, and a video generator 126.

Query retriever 122 may retrieve or obtain a query from the application interface 110 and/or video module 114. Upon obtaining a query, the query may be converted to a vector representation, for example, by encoding the sequence of words in the query in a vector space. Query retriever 122 may encode the query in a vector space using a bidirectional long short-term memory layer algorithm as follows:

h^{q}=biLSTMₗₐₛₜ(q)

where h_{q} is the last hidden vector for the query and q is the sequence of words in the query.

Span determiner 124 may generally be configured to determine an answering span along with a video that includes the best potential answer to the query. Span determiner 124 may access the video repository in data store 104 to determine top candidate videos (i.e., a threshold number of top videos, e.g., top five, top ten, etc.) that include, or may include, an answer to the query. Further, span determiner 124 may determine spans and respective scores within each candidate video that includes potential answers to the query. The answer span with the highest score may be determined to be the answer span by span determiner 124 as described in more detail below with respect to FIG. 2C.

Video generator 126 may be configured to generate a video or supplement a video to include answer span indicator. This may be done by generating a timeline for the video with markings within a timeline (e.g., highlighting, markers at start and end of the span, etc.) pointing to the start end location of the answer span. The indication of an answer span including a start and an end location for the span within the corresponding video may be received by video generator 126 from span determiner 124. Video generator 126 may provide the indication of the video with answer span locations to the video module 114 for presentation to the user device via application interface 110, such that the user device may reference the video, for example, from the video repository in a data store and present the video with the associated answer span markings. The user may then interact with the video in the same window (i.e., application interface) as the application workspace. As such, environment 100 provides an in-app video navigation system where a user may watch a video tutorial while simultaneously applying the learned steps to the application without ever having to leave the application workspace. Additionally, video module 114 may also be configured to allow a user to navigate or control the presented video, such as, pausing the video, resuming the video, jumping to another position within the video, etc. In some examples, a user may navigate the presented video using any number of key board shortcuts. In some other examples, a user may use voice commands to navigate the video.

Turning to FIG. 2A, FIG. 2A illustrates an example video module 114 of an in-app video navigation system, in accordance with embodiments of the present invention. In some embodiments, video module 114 of FIG. 1 may include a query receiver 212, a video component 214, and a table of contents component 216. Query receiver 212 may be configured to receive a user query in the form of natural language text phrase and/or voice command. In some examples, the query receiver 212 may include a text input box provided within the application interface 110. In such examples, a user may type in a text query in the text box using a keyboard, such as a manual keyboard of client device 106 or a virtual keyboard on a touch screen of client device 106. In some other examples, the query receiver 212 may include a voice receiver that may be enabled automatically at the opening of the application or manually via a mouse click or similar such processes. In such examples, a speech recognition algorithm may be used to detect natural language words and phrases in a voice command (i.e., query).

Video component 214 of video module 114 is generally configured to present a video with an answering span to the user via application interface 110. In some examples, video component 214 may obtain an indication of the video with answer span locations that includes a potential answer to the query. Video module 214 may further present the indication to the user device via application interface 110, such that the user device may reference the video, for example, from the video repository and present the video with the associated answer span markings. In some examples, video navigation system 120 may be a part of the video component 214. In other examples, video navigation system 120 may be located in a remote server, such that video module 114 may communicate with video navigation system 120 via network 102.

Table of contents component 216 may present a table of contents associated with the video that includes the answer span. Each video in data store 104 may include an associated table of contents that points to different topics covered at different section of the video. In some examples, the table of contents information is saved in association with the corresponding video. The video may be manually segmented into topics. In other examples, any known method of automatically segmenting videos into individual topics may be used to generate table of contents. Table of contents component 216 retrieves table of contents associated with the video having the answer span and presents it to the user via application interface 110 of client device 106. Table of contents component 216 may allow a user to navigate the video by clicking on the topics or picking a topic using voice commands. This gives a user flexibility in navigating the video, one via the timeline and the marked answer span, and another through the table of contents.

Referring to FIG. 2B, FIG. 2B illustrates an example video encoder 130 of an in-app video navigation system, in accordance with embodiments of the present invention. Data store 104 may include a data set of videos in a video repository and a video encoder 130 to encode the data set of videos. Video encoder 130 may be configured to determine and encode in a vector space, span embeddings for all possible spans within a video. Generally, each possible pairs of sentences within a video may be a span. Each span may be encoded as vectors within a vector space to describe the latent meaning within each span in span embeddings. In some examples, the distance between each span embedding and a query embedding (as described below with reference to FIG. 2C) may be used to determine a best span to answer the query.

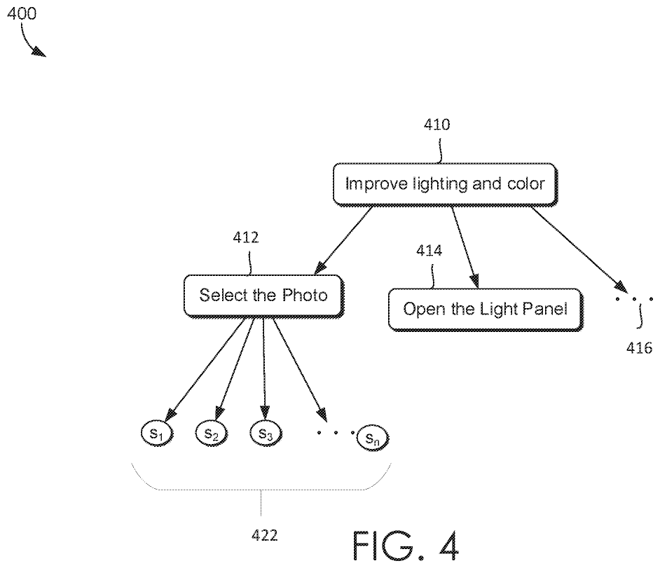

Video encoder 130 may include a sentence-level encoder 232, a passage-level encoder 234, and a span generator 236. A transcript of each video may be generated or obtained. Each video may be represented as individual sentences. This may be done by segmenting the transcript of the video into individual sentences using known sentence segmentation techniques. Sentence-level encoder 232 may be used to encode the individual sentences of video transcript as sentence embedding vectors (i.e., S₁, S₂, S₃ . . . Sₙ) in a vector space, which encodes the meaning of the sentences. For example, referring briefly to FIG. 4 the video 410 titled “Improve lighting and color” may be segmented into individual sentences 422 (S₁, S₂, S₃ . . . Sₙ). In some examples, the topics 412-416 from table of contents associated with the video may be used to segment parts of the video into the individual sentences separately. A neural network may be used to encode the video at sentence level.

Further, the videos in data store 104 may further be encoded at a passage-level, by a passage-level encoder 234. The sentence encoding vectors may be leveraged to generate passage-level representations in the vector space. Long-term dependencies between a sentence and its predecessors may be determined to learn the latent meaning of each sentence. In some examples, two bidirectional long short-term memory (biLSTM) layers may be used to encode the transcript of the corresponding video, one for encoding individual sentences and another to encode passages. For each individual sentence, the sentence-level encoder 232 may take as input the sequence of the words in the sentence, and apply a biLSTM to determine the last hidden vector as follows:

hᵢ=biLSTMₗₐₛₜ(sᵢ) for i=1 . . . n

where hᵢ is the last hidden vector for the immediate predecessor sentence and n is the total number of sentences in the video. A second biLSTM may then be applied to the last hidden vectors of the sentences to generate a passage-level encoding, by passage-level encoder 234, that is, the hidden vectors for the sentences, as follows:

p=biLSTMₐₗₗ({h₁,h₂, . . . ,hₙ})

where p encodes all hidden vectors along the sequence of sentences in the transcript of the video. These hidden vectors may represent the latent meaning of each individual sentence (S₁, S₂, S₃ . . . Sₙ) as passage-level encoding in a vector space.

Next, span generator 236 may be configured to compute embeddings of each possible span in the corresponding video. A span is represented in an index as (starting sentence location, ending sentence location). All possible spans, i.e. spans for each possible pair of two sentences may be embedded in a vector space. As such, for a transcript of a video with n sentences, there are n*(n−1)/2 spans generated and embedded in a span vector space. All possible spans may be considered by concatenating all possible pair of two sentences, using the following:

rᵢⱼ=[pᵢ,pⱼ] for i,j=1 . . . n

where [pᵢ,pⱼ] indicates a concatenation function, i is the starting sentence location and j is the ending sentence location. It should be understood that the entirety of the video (i.e., video transcript) may also be a span. In some examples, span embeddings for a span may be based on sentence-level and/or passage-level embeddings of their associated sentence pair. In such an example, the span embedding may leverage the latent meaning of the paired sentences from the sentence-level and/or passage-level embeddings to determine the meaning included in the span. These span embeddings may be saved in the data store 104 with the corresponding videos.

Turning now to FIG. 2C, FIG. 2C illustrates an example span determiner 124 of an in-app video navigation system, in accordance with embodiments of the present invention. As mentioned above with respect to FIG. 1, span determiner 124 is generally configured to determine a span and an associated video with the best potential answer to a user's search query. Span determiner 124 may include a candidate identifier 222, a span detector 224, and a span selector 226.

The candidate identifier 222 may generally be configured to identify and/or obtain top candidate videos that include a potential answer to the query. To do so, candidate identifier 222 may take as input span embeddings for each video in the video data store 104 and query embeddings generated by query retriever 122. In some examples, candidate identifier 222 may also take as input a sequence of commands executed by a user while in or using the application (e.g., icons used from a tool bar, menus selected, etc.) as context information. In some examples additional context information, such as, application status, user information, localization, geographical information, etc., may also be used as input by candidate identifier. The contextual information may be embedded as a command sequence encoding using another biLSTM layer to calculate last hidden vector to represent contextual information in a vector space as follows:

c=biLSTMₗₐₛₜ({c₁, . . . ,cₘ})

where c is the command sequence embedding of the contextual information in the vector space, and m is the number of commands.

Candidate identifier 222 may identify top candidate videos using any trained neural network trained to find an answer within transcripts to a query. Top candidate videos are videos in the data store 104 most likely to include an answer to a query. Top candidate videos may be identified based on the query, and in some examples, the command sequence. In some examples, a machine-learning algorithm may be used to identify top candidate videos based on the query and/or the command sequence. In some other examples, candidate identifier 222 may identify top candidate videos from the data store 104 based on the distance of sentence-level and/or passage-level embedding from the combination of query embedding and the command sequence embedding in a vector space. In some examples, candidate identifier 222 may retrieve top candidate videos based on their scores determined by any known machine learning technique. In some examples, a neural network may be used. The output of the machine learning technique and/or the neural network may include scores and/or probabilities for each video in the data store 104, the scores indicating the probability of an answer to the query being included in the particular video as compared to all other videos in the data store 104. Any known search technique may be used to determine top candidate videos. In one example, ElasticSearch® technique may be used to retrieve the top candidate videos along with their corresponding scores. The top candidate videos and/or an indication of the top candidate videos with the corresponding scores may then be used by the span detector 224 to determine a best span that includes an answer to the query for each of the top candidate videos.

Span detector 224 may be configured to identify the best span for each of the top candidate videos that includes a potential answer to the user query. Span detector 224 may use a machine learning algorithm to identify the best span for each top candidate video. In some examples, a deep neural network may be used. The neural network may be trained using ground truth data generated manually, as discussed in more detail below. Span detector 224, for each of the top candidate videos, may take as input query embedding generated by query retriever 122, command sequence embedding generated by the candidate identifier 222, the passage-level embedding generated by the passage-level encoder 234, and/or all possible span embeddings for each span (i.e., starting sentence location, ending sentence location) generated by the span generator 236 corresponding to the associated top candidate video. A score for each span embedding may be calculated. A span score can be determined based on the probability of the span including the best possible answer to the query, and in view of the contextual information, as compared to all other spans associated with the corresponding video. In one example, for each span, a 1-layer feed forward network may be used to combine the span embedding, the command sequence embedding, and the query embedding. A softmax may then be used to generate normalized score for each span of the corresponding video. In some examples, leaky rectified linear units (ReLU) may be used as an activation function. In another example, a cross entropy function may be used as an activation function. Score for each span may be calculated as follows:

Score_{span,ij}=softmax(FFNN{[rᵢⱼ,h^{q},c]))

where FFNN is an objective function and Score_{span,ij} is the score for the span (i, j), where i is the starting sentence location and j is the ending sentence location for the span. The span with the highest score may then be selected as the best span for that corresponding top candidate video. The best span for each of the top candidate videos and their respective score may be similarly calculated.

Next, span selector 226 may be configured to select or determine an answer span for the query, the answer span including the best potential answer to the query. Span selector 226 may receive as input top candidate video scores from candidate identifier 222 and their respective best span scores from the span detector 224. An aggregate score for each of the top candidate videos and their respective best spans may be calculated by combining the top candidate video score with its corresponding best span score. In one example, the aggregate score may be calculated as follows:

Score_{aggregate}=Score_{video}*Scoreₛₚₐₙ

where Score_{video} is the score of the candidate video and Scoreₛₚₐₙ is the best span score of the best span in the associated candidate video. Span selector 226 may determine the answer span with the best potential answer to the query as the span with the highest aggregate score. In some examples, span selector 226 may determine the answer span as the span with the highest best span score. Span selector 226 may output an indication of the answer span as a location defined by (starting sentence location, ending sentence location).

Video generator 126 may be configured to identify an answer to be presented to the user based on the query. Video generator 126 may receive indication of the answer span along with the associated video from span selector 226. A timeline for the video may be identified. The timeline can run from the beginning of the video to the ending of the video. The answer span is indicated by a starting sentence location and an ending sentence location for the span within the transcript and/or the timeline of the video. The locations for the starting and ending sentences of the span may then be used to provide markers for the span within the video timeline by the video component 214. The video component 214 and/or the video module 114 may receive an indication of the video and the span location. The video may be identified or retrieved based on the indication. A timeline may be associated with the video, and markers may be generated within the timeline to identify the answer span. The markers may include highlighting the span in the timeline, including a starting marker and ending marker in the timeline, etc. It should be understood that any markings that may bring attention to the answer span may be used. In some examples, only the answer span may be presented to the user. The answer span, corresponding video and/or the marked timeline may be sent to the video module 114 for presentation via the application interface 110 for further interaction by the user. Video module 114 may also receive voice or text commands from user to navigate the video (e.g., pause the video, resume the video, jump to another position in the video, etc.). For example, a user may provide a command to start the video at the span starting location. In response, video module 114 may start the video from the span starting location.

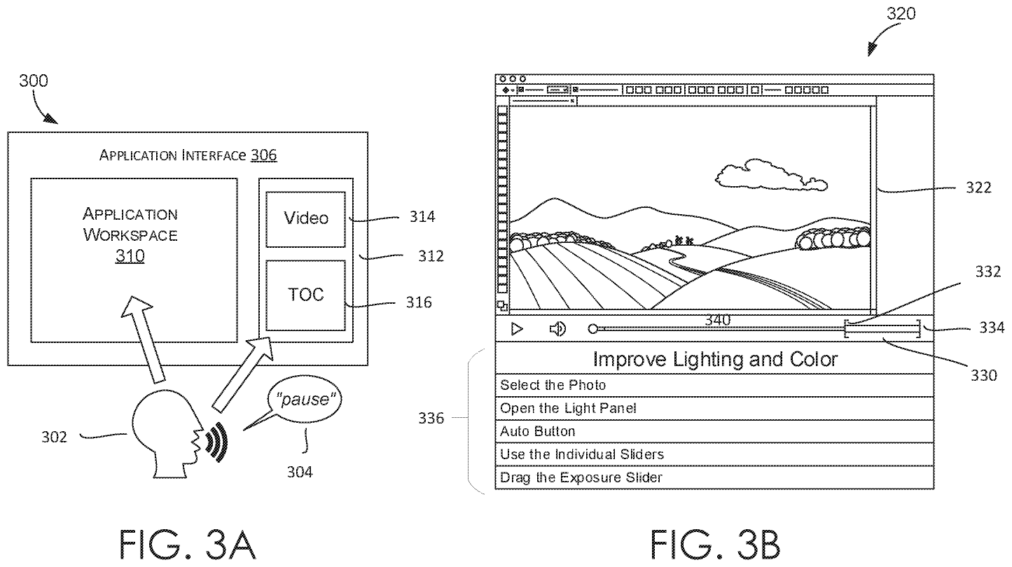

Turing now to FIGS. 3A-3B, FIGS. 3A-3B illustrates an example in-app video navigation interface, in accordance with embodiments of the present invention. FIG. 3A illustrates an overall application interface 300 for in-app video navigation. A user 302 may provide a query (e.g., text phrase, question, etc.) to the application interface 306. User 302 may provide the query in the form of voice command, such as voice command 304. In response to receiving the query, application interface 306 presents the user with an application workspace 310 and video module 312. The application workspace 310 includes the workspace within the application where the user may interact with the application. The application workspace 310 is for an application regarding which the user is submitting a query. The user may submit a query within the application, and while interacting with the application in the application workspace 310. The user may interact with the application workspace 310 as needed.

The video module 312 includes a video 314 and a table of contents 316. The video 314 is determined to include an answer span answering the query. The video 314 including the answering span may be determined by a video navigation system, such as but not limited to video navigation system 120 of FIG. 1. Table of contents 316 include table of contents divided based on topic associated with the video 314. Table of contents 316 may be generated and/or stored in a video repository, such as but not limited to video repository of data store 104 of FIG. 1. As such, user 102 may navigate the video 314 and the table of contents 316 while simultaneously performing tasks in the application workspace 310. Video module 312 may also receive voice or text commands from user 302 to navigate the video 314 (e.g., pause the video, resume the video, jump to another position in the video, etc.).

FIG. 3B illustrates one embodiment of presenting a video 320 with a marked span to answer a user query. Video module 320 may include an answer video 322 and an answer span 330 with markings to represent the starting sentence location 332 and the ending sentence location 334 within timeline 340 that correspond to the portion of the video that answers the query. A table of contents 336 may also be presented along with the video 322. As such, a user is provided with flexibility and efficiently in navigating the video. The user may choose to skip to the answer span, pick a topic from the table of contents, start the video from the beginning or jump to another position in the video.

Now turning to FIG. 4, FIG. 4 illustrates an example video segmentation and embedding 400, in accordance with embodiments of the present invention. A transcript of each video 410 may be generated. Each video may be represented as individual sentences. The transcript of the video 410 is segmented into individual sentences in a vector space 422 (i.e., S₁, S₂, S₃ . . . Sₙ) using known sentence segmentation techniques. A sentence-level encoder, such as but not limited to sentence-level encoder 232 of FIG. 2B, may be used to encode the individual sentences of video transcript as sentence embedding vectors 422 (i.e., S₁, S₂, S₃ . . . Sₙ) in a vector space, which encodes the meaning of the sentences. For example, video 410 titled “Improve lighting and color” may be segmented into individual sentence vectors 422 (i.e., S₁, S₂, S₃ . . . Sₙ). In some examples, the topics 412-416 from table of contents associated with the video may be used to segment parts of the video into the individual sentence vectors separately. A neural network may be used to encode the video at sentence level as discussed with respect to sentence-level encoder 234 and passage-level encoder 234 of FIG. 2B.

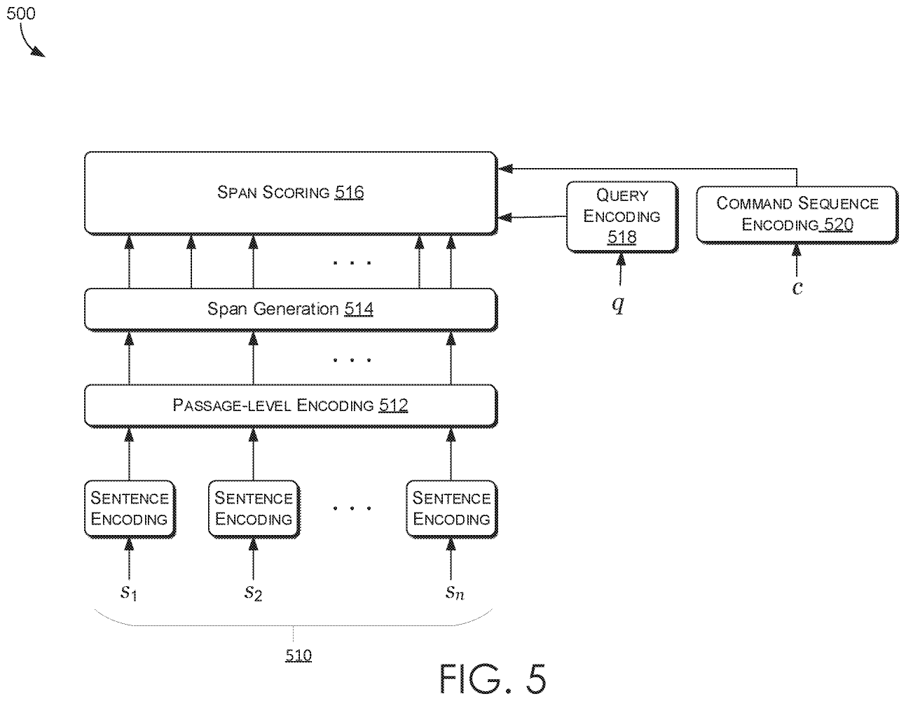

Turning now to FIG. 5, FIG. 5 illustrates an embodiment of an overall architecture 500 for an in-app video navigation system, in accordance with embodiments of the present invention. Each video (e.g., transcript of a video, etc.) in a video repository used by the in-app video navigation system may be encoded into sentence-level embeddings in a vector space and stored in a data store as sentence encodings 510 (i.e., sentence encodings S₁, S₂, S₃ . . . Sₙ). An encoder, such as but not limited to sentence-level encoder 232 of FIG. 2B, may be used to encode the transcript of a video. Passage-level encoding 512 may then be performed on the sentence encodings 510 to encode the sentences into passage-level embeddings in a vector space, such that the passage-level encoding include the latent meaning of each sentence with respect to all other sentences in the transcript of a video. A passage-level encoder, such as but not limited to passage-level encoder 234 of FIG. 2B, may be used to perform passage-level encoding 512. Next, embeddings (e.g., vector representation, etc.) for all possible spans (i.e., sentence pairs) in the video transcript may be generated for the video during span generation 514. A span generator, such as span generator 236 of FIG. 2B, may be used to identify all possible spans in the video.

When a user query is received via a client device, such as but not limited to client device 106 of FIG. 1, the query may be encoded in a vector space as query encoding (q) 518. In some examples, command sequence information such as a sequence of commands executed by a user while in or using the application (e.g., icons used from a tool bar, menus selected, etc.) may be encoded as command sequence encoding (c) 520. In some examples additional context information, such as, application status, user information, localization, geographical information, etc., may also be encoded as command sequence encoding 520.

In some examples, query encoding 518 and command sequence encoding may be used to find top candidate videos using a neural network. For each of the top candidate videos, each of the possible spans generated during span generation 514 are scored based on the question encoding 518 and the command sequence encoding 520. The highest scoring spans for each candidate video are then scored against each other to find the best answer span. Span scoring 516 may use the video score generated by the neural network and the span score for each video to calculate an aggregate score for each highest scoring spans. The span with the highest aggregate score may be presented to the user as an answer to the query.

Generally, the foregoing process can facilitate presenting specific and efficient answer spans and/or videos inside an application interface in response to user queries. By adopting an in-app and span based approach to producing answers to user query, there is no need for user to switch back and forth between an application and web browser to learn to perform tasks within the application. These approaches also provides a user with effective, efficient, and flexible way to access videos with clearly marked answers without the user having to search through long and arduous search results.

### Exemplary Machine Learning Model Training

A machine learning model or a neural network may be trained to score spans based on a query. Span selector, such as but not limited to span selector 226 of FIG. 2 may utilize a trained machine learning model to score spans in the top candidate videos. The model may be trained using training data, including a video identification, query, starting sentence location, and ending sentence location. Conventionally, search engines are trained by using crowdsourcing techniques that, given a list of questions, provide relevant parts in the videos to answer the questions. However, in order to find an answer that may only last a few seconds, the crowd sourcing workers must often watch long videos. This is both costly and time-consuming, as workers have to manually sift through long videos to find answers to often-obscure question.

Embodiments of the present invention address such problems by describing a data collection framework that allows a crowdsourcing worker to effectively and efficiently generate ground truth data to train the machine learning model to score and provide answer spans within videos. First, parts of the video that can serve as a potential answer may be identified by a worker. For this, the crowdsourcing worker may read a transcript of the corresponding video and segment the transcript such that each segment can serve as a potential answer. The segments with potential answers may vary in granularity and may overlap.

Next, a different set of crowdsourcing workers may be utilized to generate possible questions that can be answered by each potential answer segment. In some examples, multiple questions may be generated for a single segment. The questions may then be used to train the machine learning model with the segments used as ground truth spans. Advantageously, context is provided to the workers prior to generating questions.

A tolerance accuracy metric may be used to evaluate the performance of the machine learning model prior to real-time deployment. The tolerance accuracy metric may indicate how far the predicted answer span is from the ground truth span. In one example, the predicted answer span may be determined as correct if the boundaries of the predicted and the ground truth span are within a threshold distance, k. For example, a predicted answer span may be determined as correct if both the predicted starting sentence location and the predicted ending sentence location are within the threshold distance k of the ground truth starting sentence location and the ground truth ending sentence location, respectively. Further, a percentage of questions with a correct prediction in a training question data set may be calculated.

### Exemplary Flow Diagrams

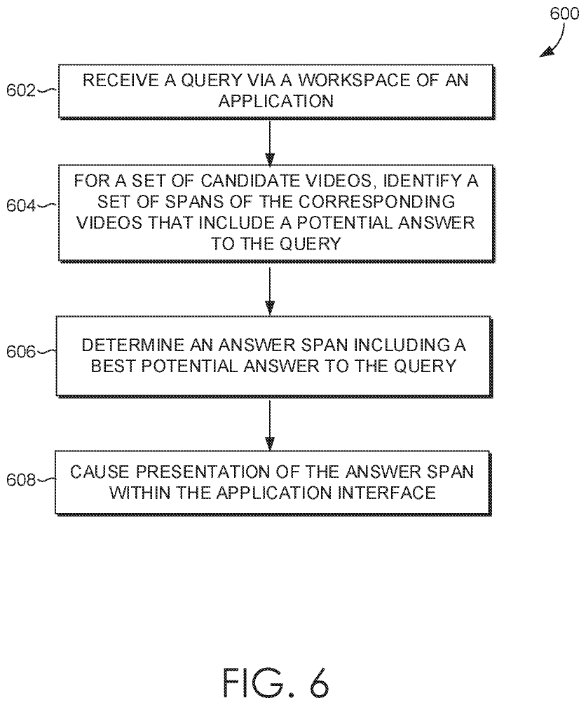

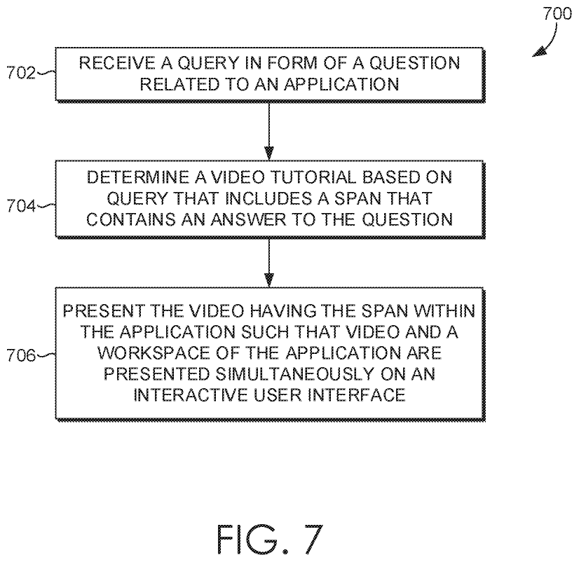

With reference now to FIGS. 6-7, flow diagrams are provided illustrating methods for in-app video navigation. Each block of the methods 600 and 700 and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

Turning initially to FIG. 6, FIG. 6 illustrates a method 600 for generating video answer spans within an application, in accordance with embodiments described herein. Initially at block 602, a query is receiver from a user via a workspace of an application. The workspace of the application may be located within an application interface of the application. The query may be received via an application interface, such as application interface 110 of FIG. 1, or a query receiver, such as query receiver 212 of FIG. 2A, or a query retriever, such as query retriever 122 of FIG. 1. At block 604, for a set of candidate videos, a set of spans of the corresponding videos are identified. The spans include a potential answer to the question related to the application. The set of candidate videos may be determined by a candidate identifier, such as candidate identifier 222 of FIG. 2C. The candidate videos may be determined from a plurality of videos stored in a video repository, such as video repository of data store 104 of FIG. 1. A span within each candidate video may be determined by a span detector, such as span detector 224 of FIG. 2C.

Next, at block 606, an answer span including a best potential answer to the query is determined. The best potential answer may be the best potential answer to the question within the query related to the application. The answer span may be determined by a span selector, such as span selector 226 of FIG. 2C. Finally, at block 608, presentation of the answer span within the application interface of the application is caused. The answer span may be presented to the user via an application interface, such as application interface 110 of FIG. 1.

Turning now to FIG. 7, FIG. 7 illustrates a method 700 for presenting a video tutorial including an answer to a query within an application, in accordance with embodiments described herein. Initially, at block 702, a query related to an application is receiver from a user in form of a question. The query may be received via an application interface, such as application interface 110 of FIG. 1, a query receiver, such as query receiver 212 of FIG. 2A, or a query retriever, such as query retriever 122 of FIG. 1. At block 704, a video tutorial based on the query is determined. The video tutorial includes a span that contains an answer to the question. A neural network(s) may be used to determine a video tutorial and a corresponding span within the video that answers the question included in the query. A span determiner, such as span determiner 124 of FIG. 1 or 2C may be used to determine the video tutorial and the corresponding span that answers the query. Finally, at block 706, the video tutorial having the span is presented to a user via an interactive user interface. The video tutorial having the span is presented simultaneously with a workspace of the application, such as application workspace 112 of FIG. 1 or application workspace 306 of FIG. 3A.

### Exemplary Operating Environment

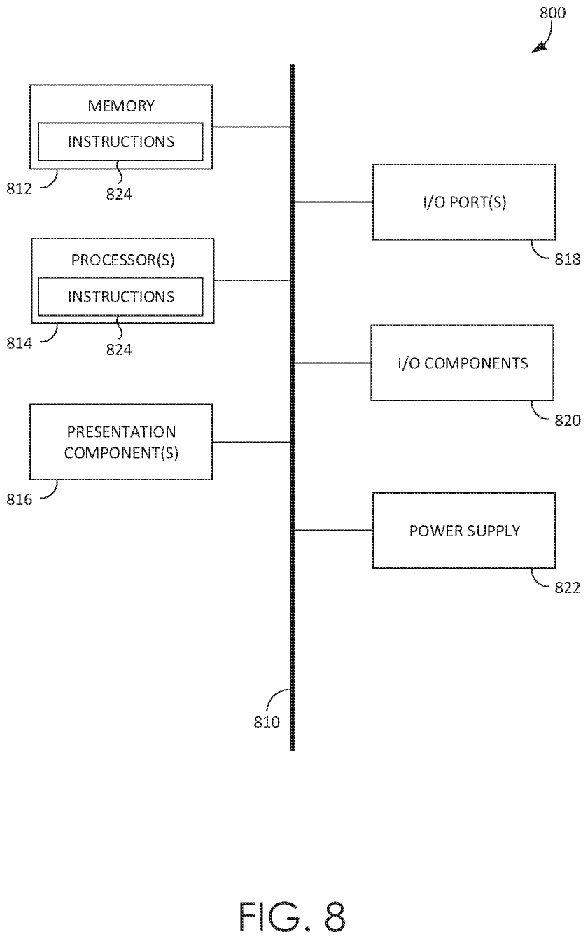

Having described an overview of embodiments of the present invention, an exemplary operating environment in which embodiments of the present invention may be implemented is described below in order to provide a general context for various aspects of the present invention. Referring now to FIG. 8 in particular, an exemplary operating environment for implementing embodiments of the present invention is shown and designated generally as computing device 800. Computing device 800 is but one example of a suitable computing environment and is not intended to suggest any limitation as to the scope of use or functionality of the invention. Neither should computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a cellular telephone, personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventor recognizes that such is the nature of the art, and reiterates that the diagram of FIG. 8 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer-storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, touch pad, touch screen, etc. The I/O components 820 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of computing device 800. Computing device 800 may be equipped with depth cameras, such as stereoscopic camera systems, infrared camera systems, RGB camera systems, touchscreen technology, and combinations of these, for gesture detection and recognition. Additionally, the computing device 800 may be equipped with accelerometers or gyroscopes that enable detection of motion. The output of the accelerometers or gyroscopes may be provided to the display of computing device 800 to render immersive augmented reality or virtual reality.

Embodiments described herein support in-app video navigation based on a user query. The components described herein refer to integrated components of an in-app video navigation system. The integrated components refer to the hardware architecture and software framework that support functionality using the in-app video navigation system. The hardware architecture refers to physical components and interrelationships thereof and the software framework refers to software providing functionality that can be implemented with hardware embodied on a device.

The end-to-end software-based in-app video navigation system can operate within the in-app video navigation system components to operate computer hardware to provide in-app video navigation system functionality. At a low level, hardware processors execute instructions selected from a machine language (also referred to as machine code or native) instruction set for a given processor. The processor recognizes the native instructions and performs corresponding low level functions relating, for example, to logic, control and memory operations. Low level software written in machine code can provide more complex functionality to higher levels of software. As used herein, computer-executable instructions includes any software, including low level software written in machine code, higher level software such as application software and any combination thereof. In this regard, the in-app video navigation system components can manage resources and provide services for the in-app video navigation system functionality. Any other variations and combinations thereof are contemplated with embodiments of the present invention.

Having identified various components in the present disclosure, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions, etc.) can be used in addition to or instead of those shown.

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations including:
receiving, via a workspace of an application, a query including a question related to the application, the workspace of the application presented within an application interface of the application;
for a set of candidate videos, identifying a set of spans of the corresponding videos that include a potential answer to the question related to the application;
determining an answer span from the identified set of spans, the answer span including a best potential answer to the question related to the application; and
causing presentation of the answer span within the application interface of the application.

2. The media of claim 1, wherein the answer span is determined based on a best span score associated with each span of the set of spans.

3. The media of claim 1, wherein the answer span is determined based on an aggregate score associated with each span of the set of spans, the aggregate score being based on a candidate video score associated with a corresponding candidate video of the set of candidate videos and a best span score associated with a corresponding span of the set of spans.

4. The media of claim 1, wherein the set of candidate videos is selected from a video repository of application tutorials.

5. The media of claim 1, wherein the set of candidate videos is determined based on contextual information associated with the application.

6. The media of claim 5, wherein the contextual information includes at least one of past user commands, application status, user information, localization and geographical information.

7. The media of claim 1, wherein the set of candidate videos is selected based on a sentence segmentation of each candidate video of the set of candidate videos.

8. The media of claim 1, wherein each span of the set of spans includes a starting sentence and an ending sentence within a corresponding candidate video of the set of candidate videos.

9. The media of claim 1, wherein the operations further comprise:
generating, for each span of the set of spans, a span embedding;
generating a question embedding based on the question; and
determining a best span score for each span of the set of spans based on the corresponding span embedding and the question embedding.

10. The media of claim 1, wherein the answer span is caused to present in conjunction with the workspace of the application within the application interface.

11. A computerized method for presenting a video including an answer to a query within an application, the method including:
receiving a query including a question related to the application, the application including contextual features;
determining a video tutorial that includes a span of content having an answer to the question, the video tutorial determined based on the query and contextual features associated with the application; and
presenting within the application, via a user interface, the video tutorial having the span, such that the video tutorial and a workspace of the application are presented simultaneously via the user interface.

12. The method of claim 11, wherein the query is received via voice command and the method further comprises a speech recognition technique to identify the query based on the voice command.

13. The method of claim 12, wherein the video further includes a table of contents associated with the video tutorial.

14. The method of claim 12, wherein the table of contents is associated with a timeline of the video tutorial.

15. The method of claim 11, wherein the span is defined as a portion of the video tutorial including the answer to the question, the portion of the video indicated by a starting location and an ending location of the answer to the question within a timeline of the video, where the starting location and the ending location are based on a location of the answer to the question in the video tutorial.

16. The method of claim 15, wherein the portion of the video is highlighted within the timeline of the video from the starting location to the ending location, and the timeline is presented on the user interface.

17. The method of claim 16, further comprising playing the video tutorial from the starting location.

18. An in-application video navigation system comprising:
one or more hardware processors and memory configured to provide computer program instructions to the one or more hardware processors;
an in-application video navigation environment configured to use the one or more hardware processors to:
generate a query embedding based on a received query including a question;
search, using the query, for candidate videos based on a video embeddings associated with a plurality of videos, each of the candidate videos including a potential answer to the question;
a means for identifying a span within each of the candidate videos, the span being most likely to include the potential answer to the question; and
a means for identifying one of the spans associated with the candidate videos as an answer span, the answer span including a best answer to the question from the spans.

19. The in-app video navigation system of claim 18, the in-app video navigation system further comprising a means for causing presentation of the answer span via an interactive user interface, the answer span presented in conjunction with a workspace of an application associated with the in-application video navigation environment.

20. The in-app navigation system of claim 19, wherein the means for presenting the answer span via an interactive user interface may further cause presentation of a table of contents associated with candidate video associated with the answer span.
